(19) United States
(12) Patent Application Publication
(10) Pub. No.: US 2025/0278824 A1
(43) Pub. Date: Sep. 4, 2025

(54) STATE DETECTING DEVICE AND STATE DETECTING METHOD

(71) Applicant: Hitachi, Ltd., Tokyo (JP)

(72) Inventors: Takashi OSHIMA, Tokyo (JP); Keisuke YAMAMOTO, Tokyo (JP); Seiji MIURA, Tokyo (JP)

(21) Appl. No.: 18/926,555

(22) Filed: Oct. 25, 2024

(30) Foreign Application Priority Data
Mar. 4, 2024 (JP) 2024-032417

(51) Int. Cl. G06T 7/00

(52) U.S. Cl. CPC G06T 7/0002; G06T 2207/20076; G06T 2207/20081; G06T 2207/20084

(57) ABSTRACT

Equipment state detection is performed by using low-cost and small-sized computing hardware in a state detecting device. Computation of a convolutional neural network is performed on an image with different numbers of expression bits, and a true state is determined from among a plurality of states of equipment on the basis of a result of the computation.

### CROSS-REFERENCE TO RELATED APPLICATION

The present application claims priority from Japanese application JP2024-032417, filed on Mar. 4, 2024, the content of which is hereby incorporated by reference into this application.

### BACKGROUND OF THE INVENTION

### 1. Field of the Invention

The present invention relates to a state detecting device and a state detecting method.

### 2. Description of the Related Art

Infrastructure equipment and plant equipment have been aging, and maintenance and management thereof are an important social problem. An automatic monitoring technology for the equipment is hence desired.

In recent years, there has been developed a system which detects an abnormality in the external appearance (a scratch, a crack, or the like) of the equipment by performing image recognition artificial intelligence (AI) processing on a camera image or a satellite image. However, a method using only an image presents problems in terms of a limitation on detection due to the limited resolution of the image and mere recognition of an abnormality in the external appearance. A technology which can detect the state of the equipment with high accuracy and high reliability by analyzing the time series signals of various sensors provided to the equipment has hence become necessary.

However, in the conventional time series signal analysis, a dedicated analysis algorithm is manually created according to types of the sensors, characteristics of the signals, a type of a state desired to be detected, and the like. It is hence difficult to construct the system in a short period of time and at low cost.

Meanwhile, there is an approach of analyzing the time series signals of the sensors by a deep neural network for the time series signals, such as a recurrent neural network (RNN) and a long short-term memory (LSTM). Yet, it is generally not easy for the deep neural network for the time series signals to learn.

Incidentally, a Transformer-based network has recently been used for natural language processing. It is possible to analyze the time series signals by the Transformer-based network. However, the Transformer-based network involves a large amount of operation and high power consumption, and thus invites an increase in cost and an increase in size of computing hardware.

In contrast, JP-2020-144619-A and JP-2023-171228-A disclose technologies of detecting an abnormality in the equipment by generating a pseudo image on the basis of the time series signals of the sensors and analyzing this image by a convolutional neural network.

It is easy for the convolutional neural network to learn as compared with the deep neural network for the time series signals. In addition, the convolutional neural network involves a small amount of operation and low power consumption as compared with the Transformer-based network.

### SUMMARY OF THE INVENTION

For wide application to various types of equipment, a reduction in cost and a reduction in size of the computing hardware need to be pursued as much as possible. In addition, for the size reduction, a reduced battery size and a fanless operation achieved by lower power consumption are also important.

Accordingly, in JP-2023-171228-A, the number of expression bits (resolution) of an image (an input image and an intermediate image) is reduced in order to further reduce the amount of operation and power consumption of the convolutional neural network. Meanwhile, an analog-to-digital (A/D) conversion technology for digitizing the outputs of the sensors has continued to progress, so that time series signals of high resolution have become available.

However, due to the reduction of the number of expression bits described above, the resolution is not fully utilized. As a result, equipment to which the application can be made is still limited.

It is an object of the present invention to perform equipment state detection by using low-cost and small-sized computing hardware in a state detecting device.

A state detecting device according to one aspect of the present invention is a state detecting device for detecting a state of equipment by using at least one sensor, the state detecting device including an image generating unit configured to convert a time series signal from the sensor into an image, a computing circuit configured to perform computation of a convolutional neural network on the image with different numbers of expression bits, and a determining unit configured to determine a true state from among a plurality of states of the equipment on the basis of a computation result of the computing circuit, the computing circuit, in a computation for a first time on the image, performing a first computation on all of image regions of the image with a first number of expression bits among the different numbers of expression bits, outputting respective first class probabilities of the plurality of states, and extracting a plurality of states having high probability values among a plurality of the first class probabilities, as state candidates, and in a computation for a second time on the image, selecting respective partial image regions having a high degree of contribution in the image for a plurality of the state candidates, respectively, on the basis of weight values of a learned final layer of the convolutional neural network, and performing a second computation on the partial image regions with a second number of expression bits higher than the first number of expression bits among the different numbers of expression bits, and outputting each of second class probabilities of the plurality of the state candidates, and the determining unit determining a state candidate having a highest probability value among a plurality of the second class probabilities, as the true state of the equipment.

According to one aspect of the present invention, it is possible to perform equipment state detection by using low-cost and small-sized computing hardware in a state detecting device.

### BRIEF DESCRIPTION OF THE DRAWINGS

FIG. 1 is a diagram illustrating a configuration of a state detecting device according to a first embodiment;

FIG. 2A is a diagram illustrating an effect of the first embodiment;

FIG. 2B is a diagram illustrating an effect of the first embodiment;

FIG. 3 is a diagram illustrating a configuration of a neural network in the first embodiment;

FIG. 4A is a diagram of assistance in explaining an operation of the first embodiment;

FIG. 4B is a diagram of assistance in explaining an operation of the first embodiment;

FIG. 5 is a diagram illustrating a configuration of an image region contribution degree table in the first embodiment;

FIG. 6A is a diagram illustrating a configuration of a state detecting device according to a second embodiment;

FIG. 6B is a diagram of assistance in explaining an operation of the second embodiment;

FIG. 7A is a diagram illustrating a configuration of a state detecting device according to a third embodiment;

FIG. 7B is a diagram of assistance in explaining an operation of the third embodiment;

FIG. 8A is a diagram of assistance in explaining a configuration of a fourth embodiment;

FIG. 8B is a diagram of assistance in explaining a configuration of the fourth embodiment;

FIG. 9A is a diagram illustrating a configuration of a state detecting device according to a fifth embodiment; and

FIG. 9B is a diagram illustrating an effect of a sixth embodiment.

### DESCRIPTION OF THE PREFERRED EMBODIMENTS

Embodiments will hereinafter be described with reference to the drawings.

### First Embodiment

FIG. 1 is a diagram illustrating a configuration of a state detecting device according to a first embodiment.

As illustrated in FIG. 1, the state detecting device according to the first embodiment includes an image generating unit 11, a bit number changeable convolutional neural network computing circuit 12, an image memory 13, a weight memory 14, a scheduler 15, a recalculation image region deciding unit 16, an image region contribution degree table 17, and a determining unit 18.

One or a plurality of sensors (not illustrated) are arranged on equipment or in the vicinity of the equipment in order to monitor the state of the equipment. Suppose that a time series signal output by each of the sensors is already digitized in a stage of sensor output or digitized by an A/D converter (not illustrated) in a stage subsequent to the sensor. The digitized time series signal (hereinafter referred to as a sensor signal) is input to the image generating unit 11.

The image generating unit 11 converts the sensor signal into an image. The bit number changeable convolutional neural network computing circuit 12 performs a neural network computation on the image, and outputs probabilities (class probabilities for a first time) of respective states. At this time, the neural network computation is performed while the image and an image as output of each layer (intermediate image) generated during the computation are read and written from and to the image memory 13. In addition, the computation is performed while weight data for a neural network stored in the weight memory 14 is read.

The neural network computation progresses according to a control signal output from the scheduler 15 to the bit number changeable convolutional neural network computing circuit 12. In addition, the computation is performed while pixels in the image and the intermediate image are selected according to a pixel selection signal output from the scheduler 15.

The scheduler 15 further outputs a bit number selection signal to the bit number changeable convolutional neural network computing circuit 12 to instruct the bit number changeable convolutional neural network computing circuit 12 to express the pixels with a low number of bits or a high number of bits.

In the neural network computation for the first time described above, the bit number selection signal gives an instruction for a low number of expression bits. Thus, the image and the intermediate image are expressed and computed with a low number of bits. As a result, the class probability output for the first time is low-accuracy class probabilities.

The class probability output for the first time (low-accuracy class probabilities) is input to the recalculation image region deciding unit 16. The class probability output for the first time has a low accuracy, and hence cannot be used to determine a true state. Yet, the class probability output for the first time has a sufficient accuracy to extract a plurality of state candidates. Hence, one of the state candidates is the true state. The recalculation image region deciding unit 16 extracts, as the state candidates, a plurality of states with high probabilities in the class probability output for the first time.

Here, as states with high probability values, a plurality of states whose probability values exceed a predetermined threshold value are extracted as the state candidates. Alternatively, as states having high probability values, a plurality of states having a predetermined number of top ranked probability values among a plurality of the class probabilities for the first time (first class probabilities) are extracted as the state candidates.

The recalculation image region deciding unit 16 further decides a region in the image (image region) which region has a high degree of contribution for each state of the state candidates, on the basis of the image region contribution degree table 17, and transmits the region as a recalculation image region to the scheduler 15.

The image region contribution degree table 17 holds information concerning image regions having high degrees of contribution for each state, on the basis of learned weight data of a final layer of the neural network.

Next, the scheduler 15 makes the bit number changeable convolutional neural network computing circuit 12 perform a neural network computation for a second time with use of the control signal as in the neural network computation for the first time. Yet, the computation for the second time calculates only the recalculation image regions corresponding to the respective state candidates transmitted from the recalculation image region deciding unit 16. Hence, the pixel selection signal output by the scheduler 15 selects pixels in the image and the intermediate image which correspond to the recalculation image regions.

Further, in the computation for the second time, the bit number selection signal gives an instruction for a high number of expression bits. Thus, each of the pixels is expressed and computed with a high number of bits. Consequently, a class probability output of higher accuracy than that in the computation for the first time is obtained at the output of the bit number changeable convolutional neural network computing circuit 12 as a result of the neural network computation for the second time.

Hence, the determining unit 18 determines that a state having a highest numerical value of probability in the high-accuracy class probability output is the true state. Thus, the equipment state detection can be performed with high accuracy.

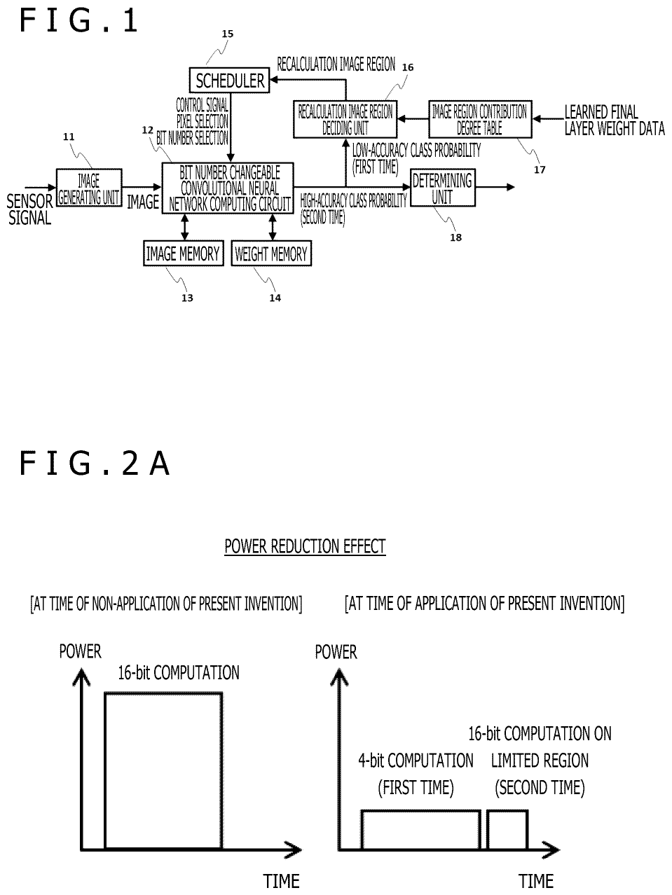

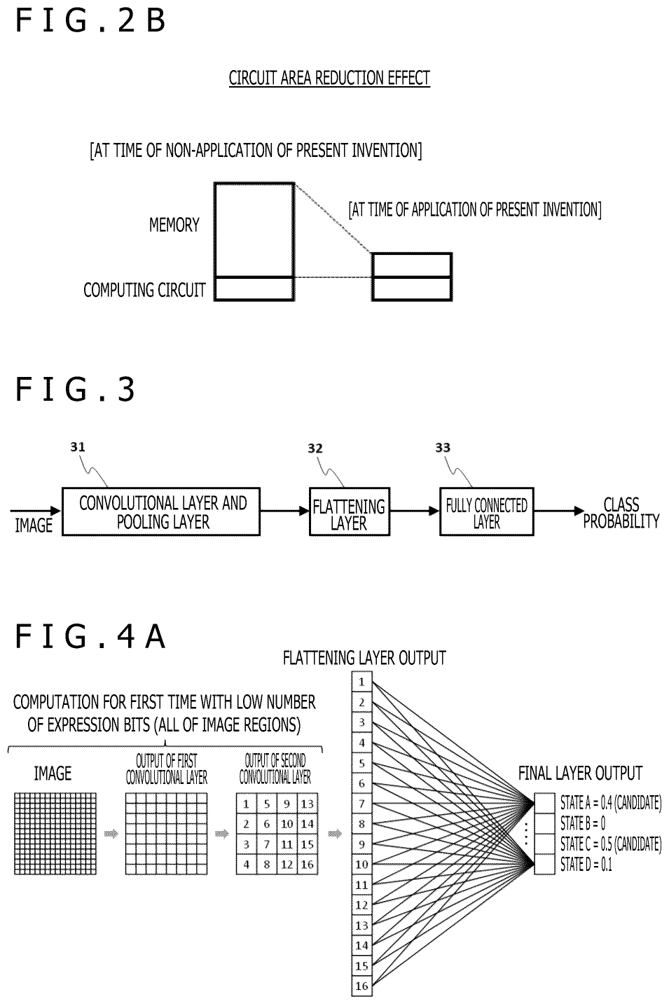

As illustrated in FIG. 2A, the present technology can reduce power consumption. In a case where the present invention is not applied, the computation with a high number of expression bits (for example, 16 bits) is performed on each image only once, and high-accuracy class probabilities are output. A state having a highest probability is determined to be the true state. Because the computation is performed with a high number of expression bits, power consumption (power consumption of memory access and power consumption of the computing circuit) is increased in proportion to the number of bits.

In a case where the present invention is applied, in contrast, the computation for the first time is performed on each image with a low number of expression bits (for example, 4 bits). A plurality of state candidates are extracted on the basis of a low-accuracy class probability output obtained by the computation for the first time, and only image regions having high degrees of contribution to the extracted states are recalculated by the computation for the second time. A state having a highest probability in a resulting high-accuracy class probability output is determined to be the true state. Power consumption can be reduced since the computation is performed with a low number of expression bits.

In addition, while the computation for the second time is necessary, the computation is performed only for a part of image regions (partial image regions), and is thus completed in a shorter time than the computation for the first time. Hence, a reduction in power consumption can be achieved with an image classification speed (that is, a state detection frequency) decreased little as compared with the case where the present technology is not applied.

As illustrated in FIG. 2B, the present invention can also reduce a mounting area. In the case where the present invention is not applied, computation is performed with a high number of expression bits (for example, 16 bits). Thus, in proportion to the number of bits, a memory capacity necessary for the image memory 13 is increased, and a circuit area of the memory is increased.

In the case where the present invention is applied, in contrast, computation is performed with a low number of expression bits (for example, 4 bits). Thus, the memory capacity and the area necessary for the image memory 13 are reduced. The computation for the second time is performed with a high number of expression bits (for example, 16 bits). Yet, the computation is performed only for a part of the image regions, so that the small memory capacity secured for the computation for the first time suffices. In general, the circuit area of the memory is larger than the area of the computing circuit. A circuit area as a whole can hence be reduced sufficiently by a reduction in the circuit area of the memory. FIG. 3 illustrates a configuration of the neural network as a target of computation of the bit number changeable convolutional neural network computing circuit 12.

A convolutional layer and pooling layer 31 as a front stage of the neural network is any appropriate combination of a plurality of convolutional layers and a plurality of pooling layers. An intermediate image of a layer at a tail end of the convolutional layer and pooling layer 31 is converted into one-dimensional data by a flattening layer 32. The one-dimensional data is input to a fully connected layer 33. The fully connected layer 33 is a final layer of the neural network as a whole.

The fully connected layer 33 performs a product-sum computation using outputs of the flattening layer 32 as a preceding layer and weights for these outputs, makes a Softmax function as an activation function act on a result of the product-sum computation, and outputs a class probability corresponding to each state as an output value of the Softmax function.

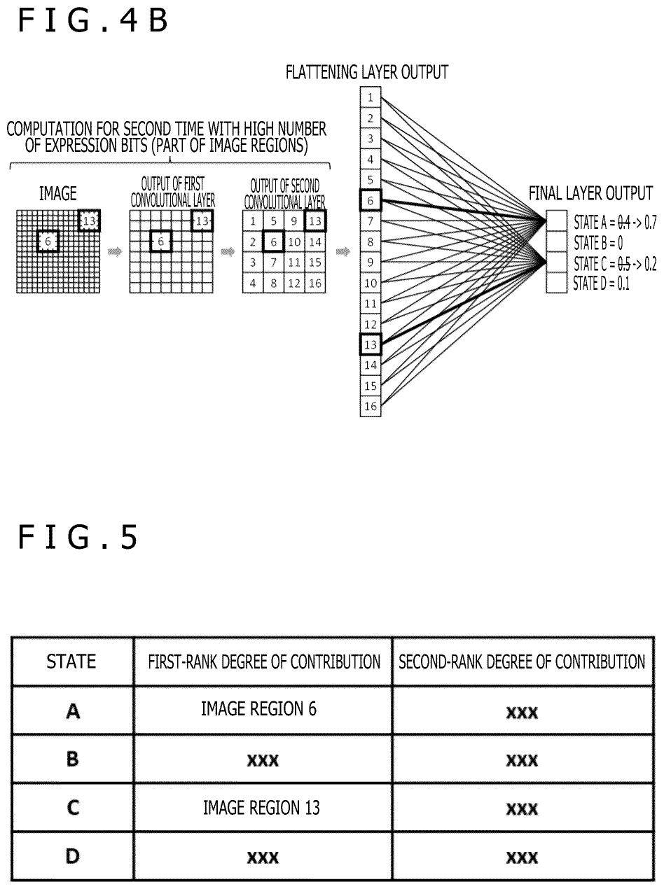

FIG. 4A and FIG. 4B illustrate states of specific operations.

FIG. 4A illustrates the neural network computation for the first time. The image is input, and is processed by two convolutional layers over all of the image regions.

At this time, the computation is performed with a low number of expression bits (for example, 4 bits), as described above. An output of a second convolutional layer is converted into one-dimensional data by the flattening layer. An output of the flattening layer is input to the fully connected layer as a single layer. This fully connected layer is the final layer of the neural network, and outputs the above-described class probabilities for the first time.

The neural network of FIG. 4A classifies four states, that is, states A, B, C, and D. The probability of the state A is 0.4 (40%). The probability of the state B is 0 (0%). The probability of the state C is 0.5 (50%). The probability of the state D is 0.1 (10%). Hence, the state A and the state C having high probabilities are extracted as the above-described state candidates.

FIG. 4B illustrates the neural network computation for the second time. As described above, the state A and the state C are extracted as the state candidates in the neural network computation for the first time. It hence suffices to perform the computation only for an image region 6 having a high degree of contribution to the state A (region denoted as “6” in an “IMAGE” in FIG. 4B) and an image region 13 having a high degree of contribution to the state C (region denoted as “13” in the “IMAGE” in FIG. 4B).

A reason why the image region 6 and the image region 13 are image regions having a high degree of contribution is as follows.

The magnitude of a degree of contribution to each state is determined by the magnitude of a weight in the final layer. The final layer is the fully connected layer. A value obtained in advance during learning is used as a weight of connection between each output of the flattening layer (16 outputs in FIG. 4A and FIG. 4B) and each state of the final layer (4 states in FIG. 4A and FIG. 4B).

In the example of FIG. 4B, a weight for a sixth output (illustrated by a thick line) in the flattening layer is largest as a weight for the state A. Hence, the sixth output among the 16 outputs of the flattening layer has a highest degree of contribution to the state A. Similarly, a weight for a 13th output (illustrated by a thick line) in the flattening layer is largest as a weight for the state C. Hence, the 13th output among the 16 outputs of the flattening layer has a highest degree of contribution to the state C.

Meanwhile, each output of the flattening layer is calculated by a convolution computation on a corresponding image region. In FIG. 4B, the sixth output of the flattening layer is calculated by a convolution computation on the image region 6. Hence, an image region having a high degree of contribution to the state A is the image region 6. Similarly, the 13th output of the flattening layer is calculated by a convolution computation on the image region 13. Hence, an image region having a high degree of contribution to the state C is the image region 13.

Accordingly, in the neural network computation for the second time, a convolution computation is performed on the image region 6 as follows, and the sixth output of the flattening layer is calculated. First, the computation of a first convolutional layer is performed on the image region 6. Next, the computation of a second convolutional layer is performed on the region obtained by the computation of the first convolutional layer (region illustrated as “6” in the “OUTPUT OF FIRST CONVOLUTIONAL LAYER” in FIG. 4B). A pixel value illustrated as “6” in the “OUTPUT OF SECOND CONVOLUTIONAL LAYER” in FIG. 4B is thereby generated. The sixth output of the flattening layer is rewritten by the pixel value from the value obtained at the time of the neural network computation for the first time.

Similarly, in the neural network computation for the second time, a convolution computation is performed on the image region 13 as follows, and the 13th output of the flattening layer is calculated. First, the computation of the first convolutional layer is performed on the image region 13. Next, the computation of the second convolutional layer is performed on the region obtained by the computation of the first convolutional layer (region illustrated as “13” in the “OUTPUT OF FIRST CONVOLUTIONAL LAYER” in FIG. 4B). A pixel value illustrated as “13” in the “OUTPUT OF SECOND CONVOLUTIONAL LAYER” in FIG. 4B is thereby generated. The 13th output of the flattening layer is rewritten by the pixel value from the value obtained at the time of the neural network computation for the first time.

Incidentally, the convolution computation in the neural network computation for the second time is performed with a high number of expression bits (for example, 16 bits), as described above. As a result of the above, in the neural network computation for the second time, the sixth output and the 13th output of the flattening layer are replaced with values of higher accuracy than those at the time of the neural network computation for the first time.

Further, a recalculation of the final layer (fully connected layer) is performed on the flattening layer outputs after the replacement, and the class probability output for the first time is updated. The class probabilities of the state A and the state C are thereby updated. In FIG. 4B, the probability of the state A is updated from 0.4 (40%) to 0.7 (70%), and the probability of the state C is updated from 0.5 (50%) to 0.2 (20%). The updated class probabilities are calculated with high accuracy. The true state can hence be determined by using the updated class probabilities. Of the updated class probabilities, the probability of the state A is highest, and thus the state A is determined to be the true state.

Incidentally, FIG. 4A and FIG. 4B represent a case where the convolutional layer and pooling layer 31 is two convolutional layers. However, the same applies also in a case of a larger number of layers and a case where a pooling layer is mixed.

FIG. 5 illustrates an example of the image region contribution degree table 17. Stored therein are the number of an image region having a highest degree of contribution to each state (first-rank degree of contribution) and the number of an image region having a next highest degree of contribution to each state (second-rank degree of contribution).

As described above, image regions having high degrees of contribution are determined on the basis of the magnitude of weights between the final layer (fully connected layer) and the flattening layer outputs. For each state of the final layer, the number of an image region corresponding to a largest weight is stored as an image region having a first-rank degree of contribution, and the number of an image region corresponding to a second largest weight is stored as an image region having a second-rank degree of contribution.

FIG. 5 corresponds to the example of FIG. 4B. The image region 6 is stored as an image region having a first-rank degree of contribution to the state A, and the image region 13 is stored as an image region having a first-rank degree of contribution to the state C. Hence, the operation illustrated in FIG. 4B can be performed after the recalculation image region deciding unit 16 decides the image regions corresponding to the state candidates by referring to the image region contribution degree table 17 illustrated in FIG. 5.

Incidentally, the image regions having a second-rank degree of contribution which are stored as illustrated in FIG. 5 may be used, and the neural network computation for the second time may be performed on the two image regions (the image region having a first-rank degree of contribution and the image region having a second-rank degree of contribution) for each state candidate.

Similarly, image regions having third- and subsequent-rank degrees of contribution may be stored as appropriate on the basis of the magnitude of weights between the final layer (fully connected layer) and the flattening layer outputs, and the neural network computation for the second time may be performed also on these image regions. The accuracy of the obtained class probabilities is further improved by including also the image regions having lower degrees of contribution in the neural network computation for the second time.

Meanwhile, the neural network computation for the second time correspondingly takes time, and thus the image classification speed (that is, the state detection frequency) is decreased. It suffices to set the number of image regions to be included in the neural network computation for the second time according to each state detection application.

As described above, in the present embodiment, the time series signal of the sensor is converted into an image, and the state of the equipment is classified by performing classification using the neural network based on the convolutional layers twice.

In the neural network computation for the first time, the image input to the neural network and the intermediate image generated during the neural network computation are expressed and computed with a low number of bits. A few state candidates having high probabilities are extracted on the basis of an obtained class probability output for the first time.

In the neural network computation for the second time, only a part of the image regions (partial image regions) which part have high degrees of contribution to the extracted state candidates are recalculated with a high number of bits. A state having the highest probability in an obtained class probability output for the second time is determined to be a final state.

Incidentally, the state candidates may be selected from states having probability values equal to or higher than a predetermined threshold value in the class probability output for the first time. Alternatively, the state candidates may be selected from states having a predetermined number of top ranked probability values among the plurality of first class probabilities in the class probability output for the first time.

In addition, in a case where a maximum probability value in the class probability output for the second time is less than a predetermined threshold value, the number of image regions may be increased, and a neural network computation for a third time may similarly be performed to determine the true state.

The configuration and the operation described above can reduce the circuit mounting area and power consumption of computing hardware that performs the equipment state detection based on the sensor, and can thereby achieve a reduction in cost and a reduction in size of the computing hardware.

### Second Embodiment

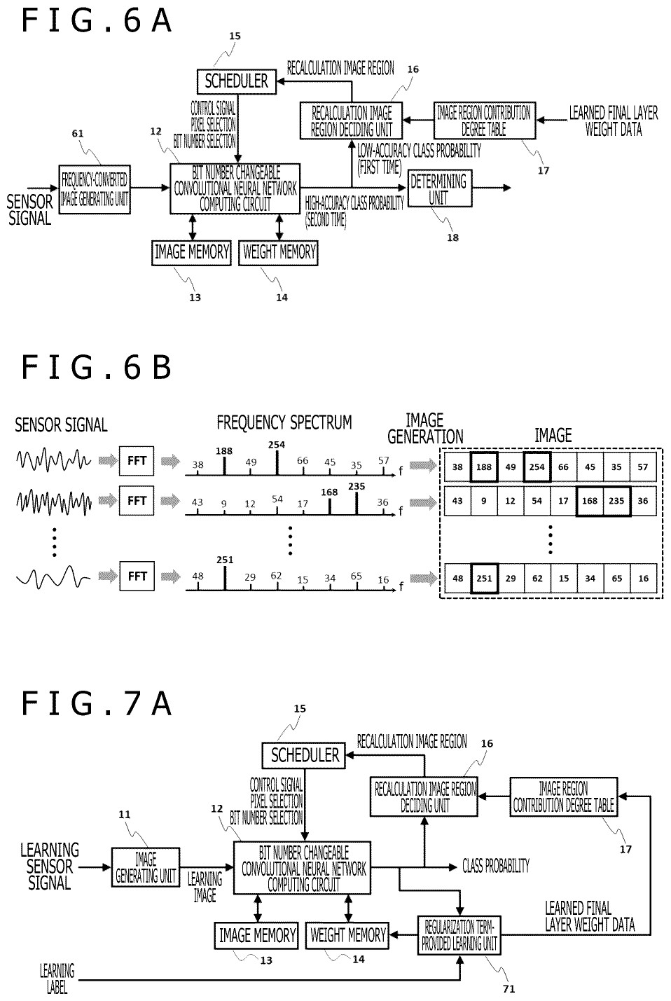

FIG. 6A is a diagram illustrating a configuration of a state detecting device according to a second embodiment. In the present embodiment, a frequency-converted image generating unit 61 in particular is used as the image generating unit 11 in the first embodiment. The other configuration and operation are similar to those of the first embodiment, and therefore description thereof will be omitted.

The frequency-converted image generating unit 61 converts each of the time series signal(s) (sensor signal(s)) of one or a plurality of sensors into frequency spectrum data, and generates an image on the basis of the frequency spectrum data. The image may be generated by a method described in JP-2023-171228-A, for example.

By including the frequency spectrum data of a plurality of sensors in one image, in particular, it is possible to realize sensor fusion, and consequently improve the sensitivity and accuracy of state detection. FIG. 6B illustrates an example thereof.

As illustrated in FIG. 6B, each of the time series signals (sensor signals) of a plurality of sensors is converted into one-dimensional frequency spectrum data by a fast Fourier transform (FFT). The image is generated as in FIG. 6B by setting each piece of one-dimensional frequency spectrum data as one row of the image and arranging these pieces of one-dimensional frequency spectrum data in a vertical direction.

Incidentally, as described in JP-2023-171228-A, the number of rows of the image may be increased by dividing each piece of one-dimensional frequency spectrum data into a plurality of pieces of one-dimensional frequency spectrum data and vertically arranging these pieces of one-dimensional frequency spectrum data. In addition, the number of rows of the image may be increased by repeatedly arranging each piece of one-dimensional frequency spectrum data in a plurality of rows. Further, these may be combined with each other. The image having a desired size is thus generated.

A reason why the image generation based on the frequency conversion as described above is suitable is as follows. In many cases, specific frequency components of each sensor signal greatly contribute to the equipment state detection. In FIG. 6B, for example, frequency components indicated by thick lines in each frequency spectrum make a great contribution.

These frequency components are formed into pixels enclosed by thick frames in “IMAGE” in FIG. 6B by image conversion. That is, unlike an ordinary image of a dog, a cat, or the like, the image generated from the sensor signals on the basis of the frequency conversion includes important information in specific pixels (more typically, specific image regions).

Hence, when the neural network of FIG. 3 is learned in advance by using such an image, the learning can be performed such that weights corresponding to the specific image regions among the weights of the final layer (fully connected layer) (weights between the above-described final layer and the flattening layer outputs) become prominently large. This enhances the validity of performing the neural network computation for the second time only on image regions having top ranked degrees of contribution as in FIG. 4B and FIG. 5.

That is, when there is no image region having a prominent degree of contribution, many image regions need to be included in the neural network computation for the second time, and thus the image classification speed (that is, the state detection frequency) is decreased. However, such a situation can be avoided.

As described above, according to the present embodiment, it is possible to enhance the validity of performing the neural network computation for the second time with use of only image regions having top ranked degrees of contribution. It is thus possible to achieve both high accuracy and high frequency (real-time characteristic) of state detection.

### Third Embodiment

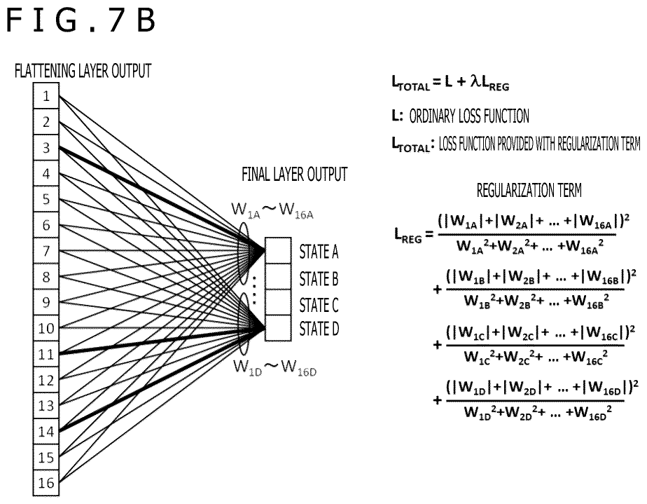

FIG. 7A is a diagram illustrating a configuration of a state detecting device according to a third embodiment. While the first embodiment illustrates a configuration of a state detecting device in an inference phase, the third embodiment illustrates a configuration of a state detecting device in a learning phase.

The present third embodiment is obtained by devising a learning method in the first embodiment. Accordingly, a regularization term-provided learning unit 71 is added to the configuration of the first embodiment.

As described above, in the present invention, the learning of the neural network is performed in advance. At a time of the learning, as illustrated in FIG. 7A, a sensor time series signal for learning (learning sensor signal) is input to the image generating unit 11, and the image generating unit 11 generates a learning image. The generated learning image is input to the bit number changeable convolutional neural network computing circuit 12. The bit number changeable convolutional neural network computing circuit 12 performs computation of the configuration of the neural network illustrated in FIG. 3, and outputs class probabilities. The class probability output is supplied to the regularization term-provided learning unit 71. A learning label is also supplied to the regularization term-provided learning unit 71.

The learning label is class probability correct answer data corresponding to the learning sensor signal. For example, in a case of four-state classification as in FIG. 4A and FIG. 4B, when the learning sensor signal corresponds to the state A, the class probability of the state A is 100%, and the class probabilities of the other states B, C, and D are 0%. The learning label is hence (1, 0, 0, 0). Similarly, when the learning sensor signal corresponds to the state B, the class probability of the state B is 100%, and the class probabilities of the other states A, C, and D are 0%. The learning label is hence (0, 1, 0, 0).

At the time of the learning, learning sensor signals corresponding to all of the states and corresponding learning labels are supplied one after another to each of the image generating unit 11 and the regularization term-provided learning unit 71 in order or randomly. Thus, class probability outputs corresponding to the learning sensor signals are supplied one after another from the bit number changeable convolutional neural network computing circuit 12 to the regularization term-provided learning unit 71 as described above, and the corresponding learning labels are simultaneously supplied to the regularization term-provided learning unit 71.

The regularization term-provided learning unit 71 updates the weights used in the neural network (FIG. 3) from the present values on the basis of a difference between the class probability output and the learning label (class probability correct answer data) supplied thereto. The updated weights are stored in the weight memory 14. Thus, the bit number changeable convolutional neural network computing circuit 12 performs a neural network computation for a next learning sensor signal (learning image) by using the updated weights stored in the weight memory 14.

By thus updating the weights of the neural network while the learning sensor signals and the corresponding learning labels are supplied one after another, the learning ultimately converges to the values of appropriate weights. The learning is then completed.

Incidentally, before the learning, the weight memory 14 stores, in advance, default weights learned by a typical image or the like. In addition, the updated weights may be the weights of all of the layers of the neural network, or may be the weights of some of the layers. It suffices to make the selection according to state detection accuracy demanded of the state detection application or the characteristic of the sensor signal being used. Suppose that at least the weights of the final layer (fully connected layer) (weights between the above-described final layer and the flattening layer outputs) directly linked with image classification are updated.

Of the weights finally obtained after the completion of the learning, the values of the weights of the final layer (“LEARNED FINAL LAYER WEIGHT DATA” in FIG. 7A) are supplied to the image region contribution degree table 17. This enables the operation illustrated in the first embodiment to be performed.

At the time of the learning described above, the bit number changeable convolutional neural network computing circuit 12 performs a high-accuracy computation with a high number of expression bits. Hence, using the bit number selection signal, the scheduler 15 instructs the bit number changeable convolutional neural network computing circuit 12 to perform the computation with a high number of expression bits.

In addition, at the time of the learning, the neural network computation is performed on all of the image regions. Hence, through the pixel selection signal, the scheduler 15 makes the bit number changeable convolutional neural network computing circuit 12 perform the computation on all pixels.

With reference to FIG. 7B, description will further be made of the updating of the weights performed by the regularization term-provided learning unit 71.

In ordinary learning, the value of each weight is updated such that an ordinary loss function L based on the difference between the class probability output and the learning label (class probability correct answer data) supplied becomes a minimum.

Hence, the gradient of the ordinary loss function L is derived as an equation by differential operation in advance, and the weights are updated by a weight updating equation on the basis of the derived equation.

In contrast, the regularization term-provided learning unit 71 according to the present embodiment updates the value of each weight such that a regularization term-provided loss function L_{TOTAL} becomes a minimum. Hence, the gradient of the regularization term-provided loss function L_{TOTAL} is derived as an equation by differential operation in advance, and each weight is updated by a weight updating equation based on the derived equation.

The regularization term-provided loss function L_{TOTAL} is obtained by adding a regularization term L_{REG} with a coefficient of A to the ordinary loss function L. That is, the regularization term-provided loss function L_{TOTAL} is as expressed by (Equation 1).

$$[ Math . 1 ]$$

$${L}_{TOTAL} = L + λ \cdot {L}_{REG} \qquad ( Equation 1 )$$

The regularization term L_{REG} is added with an aim of performing learning such that, of the weights of the final layer (that is, the weights between the final layer (fully connected layer) and the flattening layer outputs), only some of the weights become prominently large. Hence, the regularization term DREG selects the form of a function that is decreased as the values of some of the weights become prominently large. A function form as an example thereof is expressed by (Equation 2).

$$[ Math . 2 ]$$

$${L}_{REG} = \frac{{( \vert {w}_{1 A} \vert + \vert {w}_{2 A} \vert + - + \vert {w}_{16 A} \vert )}^{2}}{{w}_{1 A}^{2} + {w}_{2 A}^{2} + - + {w}_{16 A}^{2}} + \frac{{( \vert {w}_{1 B} \vert + \vert {w}_{2 B} \vert + - + \vert {w}_{16 B} \vert )}^{2}}{{w}_{1 B}^{2} + {w}_{2 B}^{2} + - + {w}_{16 B}^{2}} + \frac{{( \vert {w}_{1 C} \vert + \vert {w}_{2 C} \vert + - + \vert {w}_{16 C} \vert )}^{2}}{{w}_{1 C}^{2} + {w}_{2 C}^{2} + - + {w}_{16 C}^{2}} + \frac{{( \vert {w}_{1 D} \vert + \vert {w}_{2 D} \vert + - + \vert {w}_{16 D} \vert )}^{2}}{{w}_{1 D}^{2} + {w}_{2 D}^{2} + - + {w}_{16 D}^{2}} \qquad ( Equation 2 )$$

where W_{1A}, W_{2A}, . . . , W_{16A} are respectively the weights of connection between the first, second, and 16^{th} outputs of the flattening layer and the state A in the final layer. Similarly, W_{1B}, W_{2B}, . . . , W_{16B} are respectively the weights of connection between the first, second, and 16^{th} outputs of the flattening layer and the state B in the final layer, W_{1C}, W_{2C}, . . . , W_{16C} are respectively the weights of connection between the first, second, and 16^{th} outputs of the flattening layer and the state C in the final layer, and W_{1D}, W_{2D}, . . . , W_{16D} are respectively the weights of connection between the first, second, and 16^{th} outputs of the flattening layer and the state D in the final layer.

For example, in a case where all of the weights W_{1A}, W_{2A}, . . . , W_{16A} associated with the state A are equal to each other and are 1/16, a first term of (Equation 2) is 16. On the other hand, in a case where, of the weights associated with the state A, only W_{1A}, for example, is prominently large, and W_{1A}=1, W_{2A}=0, . . . , W_{16A}=0, the first term of (Equation 2) is 1. The same is true for the weights associated with the states B, C, and D.

Thus, the regularization term L_{REG} in (Equation 2) has the form of a function that is decreased as the values of some of the weights described above become prominently large. When this regularization term L_{REG} is included in the loss function L_{TOTAL}, the learning (updating of the weights) progresses such that not only the ordinary loss function L but also the regularization term L_{REG} becomes small at the same time. Hence, the learning progresses not only such that the difference between the class probability output and the learning label (class probability correct answer data) is reduced but also such that only some of the weights of the final layer become prominently large, as indicated by thick lines in FIG. 7B.

As a result, as in the second embodiment, the validity of performing the neural network computation for the second time only on image regions having top ranked degrees of contribution as in FIG. 4B and FIG. 5 is enhanced.

Incidentally, λ in (Equation 1) is a coefficient for determining a degree of effect of the regularization term L_{REG}. As A is increased, higher priority is given to reducing the regularization term L_{REG}, and the learning progresses such that only more partial weights of the final layer become prominently large. However, correspondingly, the action of reducing the ordinary loss function L (that is, the difference between the class probability output and the learning label) is weakened, and an error at the time of the learning is increased.

That is, as λ is increased, the error at the time of the learning is increased, but the effect of the neural network computation for the second time described above at a time of performing state detection (at a time of AI inference) is enhanced. Hence, it suffices to select an appropriate λ such that the accuracy of the class probability output for the second time becomes highest.

Incidentally, the learning based on the ordinary loss function L is also possible. Also in that case, the learning is performed as described with reference to FIG. 7A. For example, as described in the second embodiment, when the frequency-converted image generating unit 61 is used, the learning is performed as learning based on the ordinary loss function L such that only some of the weights of the final layer become prominently large. In addition, application of both the frequency-converted image generating unit 61 and the regularization term-provided learning unit 71 in the present embodiment is more effective.

In the above description, the learning of the neural network is performed using the circuit that actually performs state detection (that is, the bit number changeable convolutional neural network computing circuit 12). Yet, the same applies also in a case where the learning is performed on different hardware.

As described above, according to the present embodiment, as in the second embodiment, the validity of performing the neural network computation for the second time with use of only image regions having top ranked degrees of contribution can be enhanced. It is thus possible to achieve both high accuracy and high frequency (real-time characteristic) of state detection.

### Fourth Embodiment

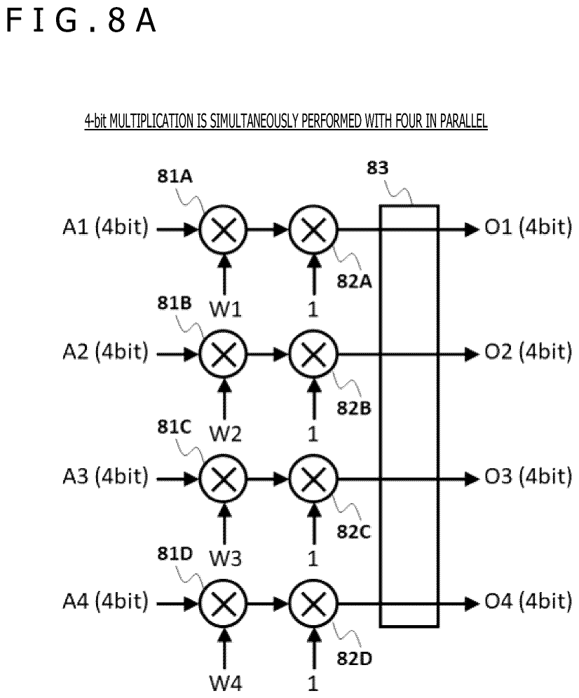

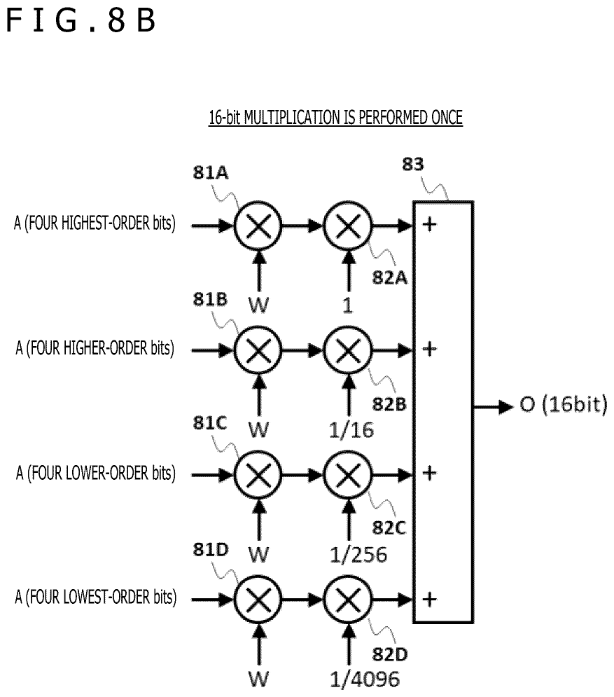

A fourth embodiment will be described with reference to FIG. 8A and FIG. 8B. The present embodiment illustrates an example of a method of changing the number of bits in the bit number changeable convolutional neural network computing circuit 12 in the first embodiment. In particular, a configuration related to a multiplying circuit for product-sum computation in a neural network computation is provided.

FIG. 8A represents a multiplying circuit with a low number of expression bits for performing the neural network computation for the first time. Specifically, a case of 4-bit expression is illustrated. The pixel values of an image or an intermediate image are input. This configuration enables the multiplication of four different pixel values A1, A2, A3, and A4 expressed by 4 bits by respective weights W1, W2, W3, and W4 to be performed with the four in parallel.

As illustrated in FIG. 8A, the multiplication is performed by using each of multipliers 81A, 81B, 81C, and 81D. The weights W1, W2, W3, and W4 are expressed by a bit length necessary for ensuring accuracy, such as 8 bits, for example. In that case, each of the multipliers 81A, 81B, 81C, and 81D is a multiplier whose input is 4 bits×8 bits and whose output is 4 bits. The multiplication outputs with the four in parallel are multiplied by 1 by subsequent multipliers 82A, 82B, 82C, and 82D (that is, the values of the multiplication outputs do not change), further pass through a passing or adding unit 83 as they are, and are then output as four independent 4-bit multiplication outputs O1, O2, O3, and O4.

FIG. 8B represents a multiplying circuit with a high number of expression bits that is implemented in the neural network computation for the second time. Specifically, a case of 16-bit expression is illustrated. As described above, the pixel values of a part of the image regions of the image or the intermediate image are input. This configuration multiplies one pixel value A expressed by 16 bits by a weight W (expressed by 8 bits, for example).

A feature lies in that the four multipliers 81A, 81B, 81C, and 81D whose input is 4 bits×8 bits and whose output is 4 bits, which are used in the multiplication with a low number of expression bits (FIG. 8A), are also shared in the multiplication with a high number of expression bits (FIG. 8B). Hence, the 16-bit pixel value A is divided into four parts from high-order bits, and the four parts are respectively supplied to the multipliers 81A, 81B, 81C, and 81D.

The subsequent multipliers 82A, 82B, 82C, and 82D multiply the outputs of these multipliers by 1, 1/16, 1/256, and 1/4096, respectively. These multiplication outputs are added together in the passing or adding unit 83. A result O of the multiplication of the pixel value A expressed by 16 bits by the weights W is thus obtained.

As described above, the passing or adding unit 83 adopts a circuit configuration that has a function of passing the four inputs as they are at the time of the multiplication with a low number of expression bits (FIG. 8A), and has a function of producing an output by adding together the four inputs at the time of the multiplication with a high number of expression bits (FIG. 8B).

In addition, as described above, the multiplier 82A multiplies the input by 1 both at the time of the multiplication with a low number of expression bits (FIG. 8A) and at the time of the multiplication with a high number of expression bits (FIG. 8B). The multiplier 82A hence does not cause a change in the value. Thus, in actuality, the multiplier 82A does not have to be implemented in the circuit.

In addition, the multipliers 82B, 82C, and 82D perform multiplication by 1 at the time of the multiplication with a low number of expression bits (FIG. 8A), and respectively perform multiplication by 1/16, 1/256, and 1/4096 at the time of the multiplication with a high number of expression bits (FIG. 8B). The multipliers 82B, 82C, and 82D may hence be implemented as a circuit that switches between a passing function and a right 4-bit shift function ( 1/16), a right 8-bit shift function (1/256), or a right 12-bit shift function (1/4096).

As described above, according to the present embodiment, computation with a low number of expression bits in the neural network computation for the first time and computation with a high number of expression bits in the neural network computation for the second time can be implemented by sharing of the circuit.

Hence, it is possible to further reduce the circuit mounting area of the computing hardware that performs the equipment state detection on the basis of the sensor, and thereby achieve a reduction in cost and a reduction in size of the computing hardware.

### Fifth Embodiment

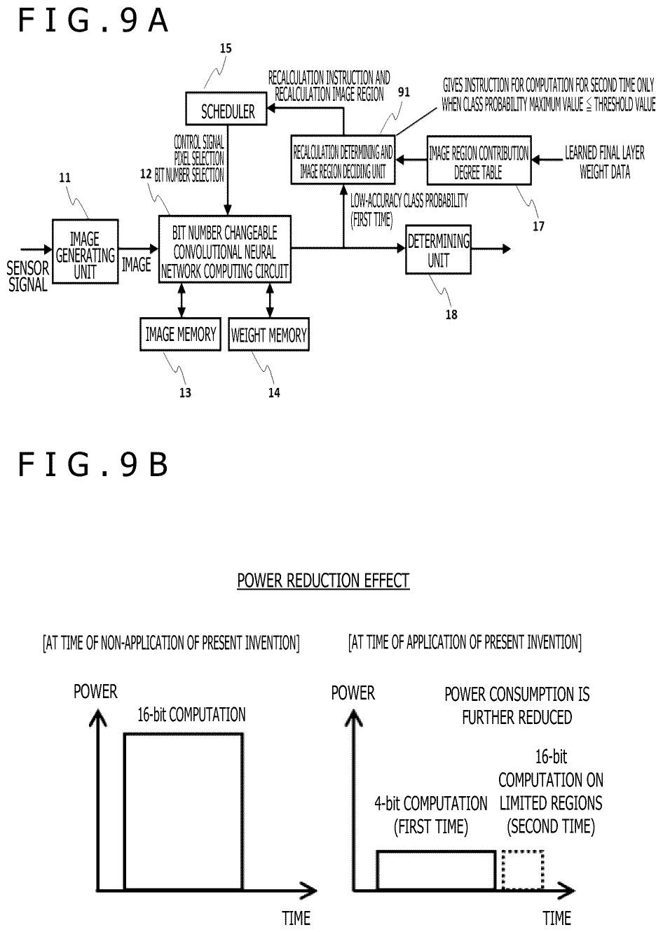

FIG. 9A is a diagram illustrating a configuration of a state detecting device according to a fifth embodiment. In the present embodiment, the recalculation image region deciding unit 16 in the first embodiment is replaced with a recalculation determining and image region deciding unit 91. The other configuration and operation are similar to those of the first embodiment, and therefore description thereof will be omitted.

In a case where a maximum value of the class probabilities included in the class probability output for the first time (low-accuracy class probabilities) exceeds a predetermined threshold value, the recalculation determining and image region deciding unit 91 does not effect the neural network computation for the second time, and the determining unit 18 determines a state corresponding to the maximum class probability value as the true state.

The class probability output for the first time is of low accuracy. Yet, in a case where the class probability value is high enough to exceed the predetermined threshold value, there is a strong possibility of the corresponding state being the true state. This can reduce power consumption necessary for the neural network computation for the second time, as illustrated in FIG. 9B.

Incidentally, in a case where the maximum value of the class probabilities included in the class probability output for the first time is equal to or less than the predetermined threshold value, the recalculation determining and image region deciding unit 91 instructs the scheduler 15 to effect recalculation, and transmits recalculation image regions. The neural network computation for the second time is then performed as in the first embodiment. The other configuration and operation are also similar to those of the first embodiment.

In addition, in a case where a ratio between a maximum value of the probabilities and a second highest value in the class probability output for the first time exceeds a predetermined threshold value, the neural network computation for the second time may not be performed.

According to the present embodiment, it is possible to further reduce power consumption of the computing hardware that performs the equipment state detection on the basis of the sensor, and thereby achieve a reduction in size of the computing hardware.

In the foregoing embodiments, processing may be performed by executing a program. In this case, a computer executes the program by a processor (for example, a central processing unit (CPU) and a graphics processing unit (GPU)), and performs the processing specified by the program while using storage resources (for example, a memory), an interface device (for example, a communication port), and the like. Hence, an entity of the processing to be performed by executing the program may be the processor. Similarly, the entity of the processing to be performed by executing the program may be a controller, a device, a system, a computer, or a node including the processor.

The program may be installed from a program source to the computer. The program source may be, for example, a program distributing server or a storage medium readable by the computer. In a case where the program source is the program distributing server, the program distributing server may include a processor and storage resources storing the program to be distributed, and the processor of the program distributing server may distribute, to other computers, the program to be distributed. In addition, in the embodiments, two or more programs may be implemented as one program, or one program may be implemented as two or more programs.

In the foregoing embodiments, the time series signal of a sensor is converted into an image, and states of the equipment are classified by performing classification using the convolutional neural network twice. In a classification for the first time, an input image of the convolutional neural network and an input image of an intermediate layer are expressed and computed with a low number of bits. A few state candidates having high class probabilities are extracted on the basis of a classification result obtained.

In a classification for the second time, only a part of the image regions which part have high degrees of contribution to the extracted state candidates are recalculated by the convolutional neural network. At this time, the corresponding regions of the input image and the input image of the intermediate layer are expressed and computed with a high number of bits. A state having a highest class probability in a classification result for the second time is determined to be a final state.

According to the foregoing embodiment, it is possible to perform the equipment state detection on the basis of the sensor by using low-cost and small-sized computing hardware, and implement highly sensitive state detection by utilizing the high resolution of the sensor signal.

What is claimed is:

1. A state detecting device for detecting a state of equipment by using at least one sensor, the state detecting device comprising:
an image generating unit configured to convert a time series signal from the sensor into an image;
a computing circuit configured to perform computation of a convolutional neural network on the image with different numbers of expression bits; and
a determining unit configured to determine a true state from among a plurality of states of the equipment on a basis of a computation result of the computing circuit,
the computing circuit,
in a computation for a first time on the image,
performing a first computation on all of image regions of the image with a first number of expression bits among the different numbers of expression bits, outputting respective first class probabilities of the plurality of states, and extracting a plurality of states having high probability values among a plurality of the first class probabilities, as state candidates, and,
in a computation for a second time on the image,
selecting respective partial image regions having a high degree of contribution in the image for a plurality of the state candidates, respectively, on a basis of weight values of a learned final layer of the convolutional neural network, and
performing a second computation on the partial image regions with a second number of expression bits higher than the first number of expression bits among the different numbers of expression bits, and outputting each of second class probabilities of the plurality of the state candidates, and
the determining unit
determining a state candidate having a highest probability value among a plurality of the second class probabilities, as the true state of the equipment.

2. The state detecting device according to claim 1, wherein
the computing circuit,
in the computation for the first time on the image,
extracts, as the plurality of the state candidates, states whose probability values exceed a predetermined threshold value as the states having the high probability values.

3. The state detecting device according to claim 1, wherein
the computing circuit,
in the computation for the first time on the image,
extracts, as the plurality of the state candidates, states having a predetermined number of top ranked probability values among the plurality of the first class probabilities as the states having the high probability values.

4. The state detecting device according to claim 1, wherein
the computing circuit,
in the computation for the second time on the image,
performs the second computation on the partial image regions and partial regions of an intermediate layer corresponding to the partial image regions.

5. The state detecting device according to claim 1, further comprising:
an image region contribution degree table configured to hold information concerning the partial image regions having the high degree of contribution to the plurality of the states,
wherein the computing circuit,
in the computation for the second time on the image,
refers to the image region contribution degree table, and selects the respective partial image regions having a high degree of contribution in the image for the plurality of the state candidates, respectively.

6. The state detecting device according to claim 5, wherein
the image region contribution degree table is produced by referring to the weight values of the learned final layer of the convolutional neural network.

7. The state detecting device according to claim 1, wherein
the image generating unit
converts the time series signal into frequency spectrum data, and
generates the image on a basis of the frequency spectrum data.

8. The state detecting device according to claim 7, wherein
the image generating unit
converts each of a plurality of time series signals from a plurality of the sensors into the frequency spectrum data, and
generates the image by using a plurality of pieces of the frequency spectrum data.

9. The state detecting device according to claim 1, further comprising:
a regularization term-provided learning unit configured to perform learning using a regularization term,
wherein the regularization term-provided learning unit
applies values obtained by learning based on a loss function including the regularization term to the weight values of the final layer, and
performs the learning such that the relatively larger some of the weight values among the weight values of the final layer, the smaller a value of the regularization term.

10. The state detecting device according to claim 9, wherein
the learning is performed with use of the computing circuit.

11. The state detecting device according to claim 1, wherein
the computing circuit performs the computation with the different numbers of expression bits by using a common multiplying circuit.

12. The state detecting device according to claim 1, wherein
the computing circuit,
in the computation for the first time,
does not perform the computation for the second time when a maximum probability value among the plurality of the first class probabilities exceeds a predetermined threshold value, and
the determining unit
determines the state candidate having the maximum probability value as the true state of the equipment.

13. The state detecting device according to claim 1, wherein
the computing circuit,
in the computation for the first time,
does not perform the computation for the second time when a ratio between a maximum probability value and a second highest probability value among the plurality of the first class probabilities exceeds a predetermined threshold value, and
the determining unit
determines the state candidate having the maximum probability value as the true state of the equipment.

14. The state detecting device according to claim 1, wherein
the computing circuit,
in the computation for the second time,
when a maximum probability value among the plurality of the second class probabilities is less than a predetermined threshold value,
increases the number of the partial image regions having the high degree of contribution in the image, and further performs a computation for a third time on the image.

15. A state detecting method for detecting a state of equipment by using at least one sensor, the state detecting method comprising:
an image generating step of converting a time series signal from the sensor into an image by an image generating unit;
a computing step of performing computation of a convolutional neural network on the image with different numbers of expression bits by a computing circuit; and
a determining step of determining a true state from among a plurality of states of the equipment by a determining unit on a basis of a computation result of the computing circuit,
the computing step,
in a computation for a first time on the image,
performing a first computation on all of image regions of the image with a first number of expression bits among the different numbers of expression bits, outputting respective first class probabilities of the plurality of states, and extracting a plurality of states having high probability values among a plurality of the first class probabilities as state candidates, and,
in a computation for a second time on the image,
selecting respective partial image regions having a high degree of contribution in the image for a plurality of the state candidates, respectively, on a basis of weight values of a learned final layer of the convolutional neural network, and
performing a second computation on the partial image regions with a second number of expression bits higher than the first number of expression bits among the different numbers of expression bits, and outputting each of second class probabilities of the plurality of the state candidates, and
the determining step
determining the state candidate having a highest probability value among a plurality of the second class probabilities, as the true state of the equipment.
